(19) United States
(12) Patent Application Publication
(10) Pub. No.: US 2011/0109959 A1
(43) Pub. Date: May 12, 2011

(54) STEREOMICROSCOPE

(75) Inventor: Ulrich Sander, Rebstein (CH)

(73) Assignee: LEICA INSTRUMENTS (SINGAPORE) PTE. LTD., Singapore (SG)

(21) Appl. No.: 12/940,072

(22) Filed: Nov. 5, 2010

(30) Foreign Application Priority Data
Nov. 6, 2009 (DE) 10 2009 046 449.2

(51) Int. Cl. G02B 21/02; G02B 21/22; G02B 21/06

(52) U.S. Cl. 359/376

(57) ABSTRACT

Stereomicroscope having a main objective (2) and a zoom system (7) provided downstream of the main objective (2), wherein between the objective (2) and the zoom system (7) is provided a first deflector (30) for deflecting viewing beam pencils emanating from the objective (2) into the zoom system, the zoom system (8) comprising substantially horizontally extending magnification and viewing channels (7a to 7d), wherein the first deflector (30) is of semitransparent construction, while a first illuminating device (50; 60, 65) is provided for illuminating an object that is to be viewed through the first deflector 30 and the main objective 2.

### CROSS REFERENCE TO RELATED APPLICATIONS

This application claims priority of the German patent application number 10 2009 046 449.2 filed Nov. 6, 2009, the entire disclosure of which is incorporated by reference herein.

### FIELD OF THE INVENTION

The present invention relates to a stereomicroscope having a main objective and a zoom system provided downstream of the main objective, wherein between the objective and the zoom system is provided a first deflector for deflecting viewing beam pencils emanating from the objective into the zoom system, and wherein the zoom system comprises substantially horizontally extending magnification and viewing channels.

### BACKGROUND OF THE INVENTION

Stereomicroscopes with horizontally arranged zoom systems are known. Reference is made for example to DE 102 55 960 A1. Stereomicroscopes of this kind are characterised by their very low height which is very favourable for one or more viewers or observers, for ergonomic reasons.

Stereomicroscopes of this kind are characterised in that a deflector is provided, between a main objective which is constructed with a perpendicularly extending optical axis and a zoom system extending substantially horizontally or having a horizontally extending optical axis, said deflector deflecting perpendicularly extending observation beam paths into the horizontal direction.

The provision of an illuminating device for certain applications may present problems in arrangements of this kind Stereomicroscopes or operating microscopes used in ophthalmology for example are supposed to make it possible to render the red reflex visible on a retina that is under observation. To do this it is necessary to provide light that strikes the pupil perpendicularly. Such light is absorbed in spectral regions by the retina, and only reflected in the red range, thus producing the red reflex.

### SUMMARY OF THE INVENTION

The aim of the present invention is to provide a stereomicroscope of the lowest possible height which has simple and cheaply produced means for observing the red reflex.

This aim is achieved with a stereomicroscope having the features of claim 1.

The provision according to the invention of a semitransparent deflector and an illuminating device for illuminating the object that is to be observed through this semitransparent deflector and the main objective results in a very compact 0° illumination that is obtained at low cost. In particular, there is no need to provide additional deflectors for illumination in the observation beams or observation beam pencils in order to obtain 0° illumination. It should be mentioned that the partly transparent deflectors that are discussed within the scope of the invention may have any desired division ratios, i.e. ratio of reflection to transmission. In particular, semitransparent deflectors may be used which reflect and transmit light equally.

Advantageous embodiments of the invention are the subject of the dependent claims.

Preferably, the zoom system has at least three and preferably four magnification and viewing channels extending substantially horizontally. This results in an operating microscope having two viewing beam paths for a main operator and two viewing beam paths for an assistant. By means of the illuminating device for 0° illumination provided according to the invention it is possible to provide both the main surgeon and the assistant with a red reflex in a particularly effective way. Conventional operating microscopes were often deficient in that the red reflex was perfectly visible to the main surgeon but could not be properly seen by the assistant. Simpler embodiments may also be envisaged in which the zoom system has only two magnification and viewing channels. This provides, for example, stereoscopic viewing for one observer or monoscopic viewing for two observers.

The main objective usefully has a substantially perpendicularly extending optical axis, the semitransparent deflector being arranged at an angle of substantially 45° relative to the optical axis of the main objective. This makes it possible to deflect beam paths passing perpendicularly through the objective into the horizontally arranged zoom element in a geometrically optimum manner while minimising the overall height of the stereomicroscope.

It has been found to be particularly favourable to mount the illuminating device above the semitransparent deflector on the opposite side thereof with respect to the objective or zoom system. This means that observation beams emanating from the object are reflected on a first or lower side of the semitransparent deflector into the zoom system, while light emanating from the illuminating device strikes a second or upper side of the semitransparent deflector, and is partly transmitted and partly reflected thereby.

It is preferable that the illuminating device is mounted substantially on the optical axis or on an extension of the optical axis of the main objective, particularly symmetrically around it. This arrangement of the illuminating device is very space-saving. The geometric arrangement of the illuminating device around the optical axis of the objective allows particularly uniform and homogeneous 0° illumination, the illuminating device preferably comprising a planar light source.

It is particularly preferable that the illuminating device should have at least one light-emitting diode, particularly an organic light-emitting diode (in English, organic LED-OLED). Light-emitting diodes of this kind, particularly OLEDs, may be produced in very flat structures, so that they can be mounted in a microscope body without appreciably increasing the bulk or height of the construction. They are also suitable for providing a planar light source. Within the scope of the present invention it is also provided that light-emitting diodes of this kind, particularly OLEDs, are arranged in concentric circles, ellipses, polygons, for example rectangles etc. It is also envisaged that the light-emitting diodes be selectively supplied with energy, so that any desired areas or structures can be used for illumination as required. For example, in the case of light-emitting diodes arranged concentrically around the optical axis of the main objective, it is possible to supply all the rings or some of the rings with energy for planar illumination, or alternatively to provide illumination at a certain angle, for example 0°, 2° or 6° illumination, by supplying specific rings with energy.

Expediently, at least one light trap is associated with the illuminating device. Using light traps of this kind that are constructed as black glass elements, for example, it is possible to minimise or prevent any disruptive light reflections that may occur. Alternatively or in addition to black glass elements of this kind it is also possible to use other highly absorbent elements, for example highly absorbent special coatings vapour-deposited on sheets of glass.

### BRIEF DESCRIPTION OF THE DRAWING VIEWS

Preferred embodiments of the invention will now be described in more detail by reference to the attached drawings, wherein:

FIG. 1 shows a schematic side view of the overall construction of a preferred embodiment of the stereomicroscope according to the invention, and

FIG. 2 shows a corresponding side view of the overall construction of another preferred embodiment of the stereomicroscope according to the invention.

### DETAILED DESCRIPTION OF THE INVENTION

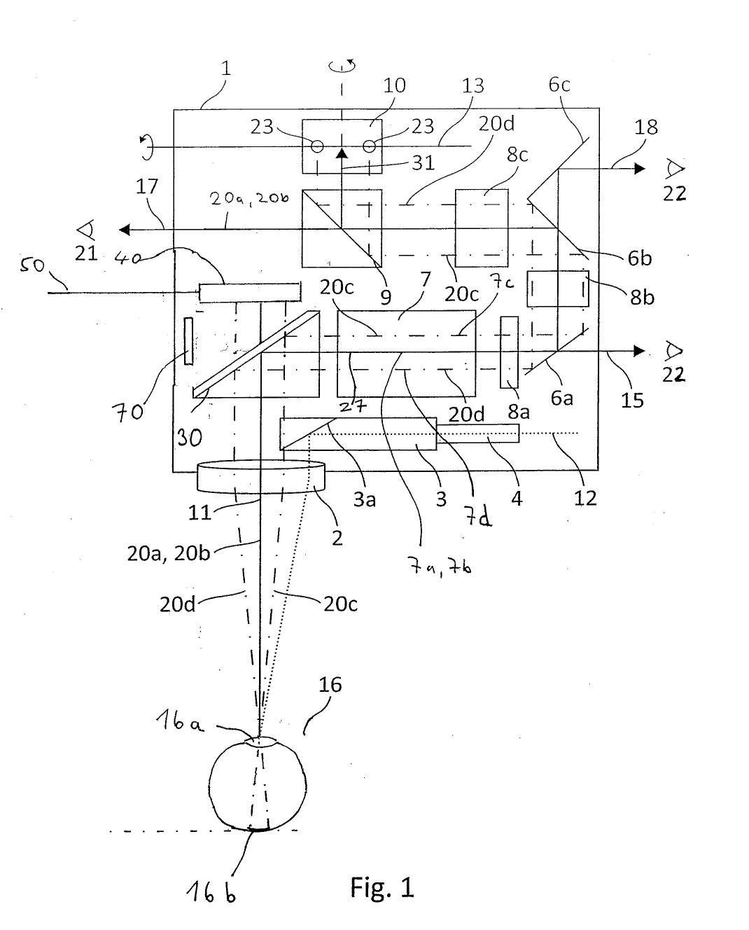

FIG. 1 (schematically) shows a microscope body of a preferred embodiment of the stereomicroscope according to the invention which is designated 1. For a definition of the directional data used in the description it should be assumed that the left-hand edge in FIG. 1 is the front side and the right-hand edge is the rear side of the microscope. The side facing the onlooker is referred to as the right-hand side of the microscope, while the side facing away from the onlooker is referred to as the left-hand side of the microscope. The stereomicroscope shown is intended to be used for viewing an object 16, in particular an eye. The stereomicroscope shown is in particular an ophthalmological microscope.

The stereomicroscope comprises as main optical components a main objective 2, a zoom system 7 and at least one tubular eyepiece system (not shown).

Between the main objective 2 and the zoom system 7 is provided a first deflector 30 which is of semitransparent construction, as will be explained in more detail hereinafter. Behind the zoom system 7 are provided further deflectors 6a, 6b, 6c, 9, 10 and optical accessories 8a, 8b, 8c.

Running substantially vertically through the main objective 2 with its optical axis 11 are two main observation beam pencils 20a, 20b and two assistant observation beam pencils 20c, 20d which after being correspondingly deflected (at right angles) by the first deflector 30 pass into the substantially horizontally extending main or assistant viewing channels 7a, 7b, 7c, 7d of the zoom system.

The two main viewing beam pencils 20a, 20b are located one behind the other in the direction of viewing of FIG. 1, so that only one of these beam pencils can be shown in the drawing. The same is true of the viewing channels 7a and 7b of the zoom system. Expediently, the four main or assistant viewing beam pencils 20a to 20d are symmetrically distributed about the optical axis 11 of the main objective 2. Advantageously, the common axis of the viewing beam pencils 20a to 20d may also pass through the main objective non-centrically, i.e. may run parallel to the axis 11. The same is true of the central axis 27 of the zoom system 7, around which the beam pencils 20a to 20d are arranged symmetrically. The zoom system 7 comprises four viewing channels, according to the arrangement of the viewing beam pencils, namely two main viewing channels 7a, 7b and two assistant viewing channels 7c, 7d.

It will be noticed that the main viewing channels 7a, 7b extend in a horizontal plane, i.e. level with the central axis 27, while the assistant viewing channels 7c, 7d extend at a perpendicular distance from one another above or below the central axis 27. The arrangement shown achieves a very dense packing of the viewing channels 7a to 7d, as a result of which a compact overall construction for the stereomicroscope according to the invention can be obtained.

After exiting from the zoom system 7 the viewing beam pencils 20a to 20d are further deflected by the further deflector 6a.

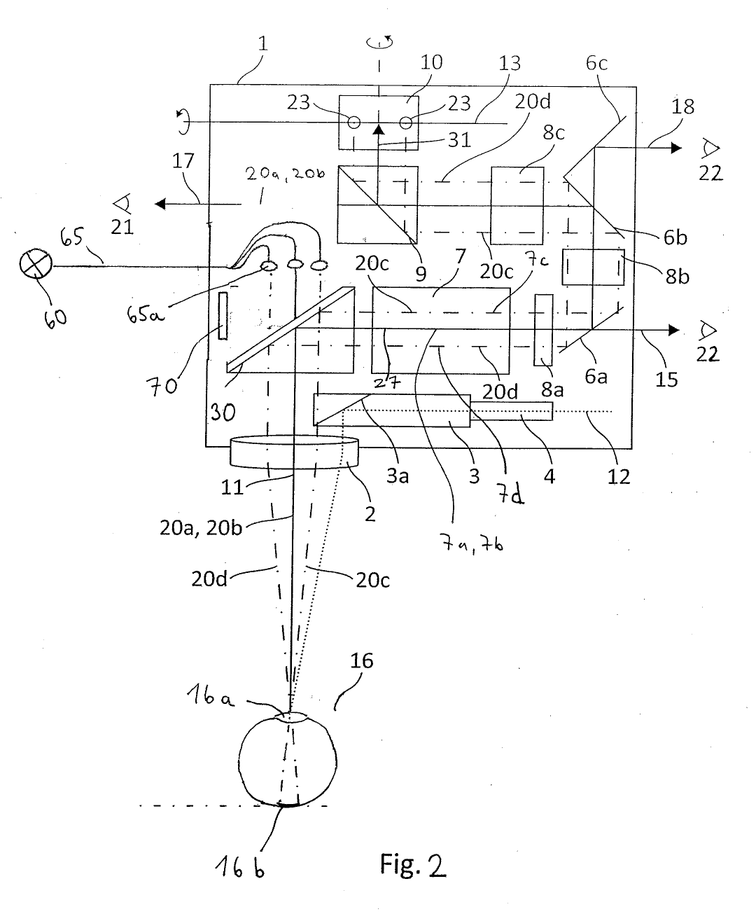

By means of this deflector 6a the viewing beam pencils 20a to 20d are essentially deflected back into the vertical. Then they strike another deflector 6b, by means of which they are deflected into the horizontal once again, as a result of which, optionally after passing through the further optical components generally designated 8c which may be provided, they strike the deflector 9, the function of which is explained hereinafter. It should be mentioned at this point that the deflector 6a and/or the deflector 6b may be semitransparent or in the form of optical beam splitters, thus making it possible to define viewing axes designated 15 and 18, respectively. For the definition of the viewing axis 18, another deflector 6c is used, as shown in FIGS. 1 and 2. The viewing axes 15, 18 are expediently used in connection with a 180° viewing by an assistant, the vertical spacing between the object 16 and the viewing axis 18 being greater than that between the object 16 and the viewing axis 15.

However, it should be pointed out that these viewing axes 15, 18 are purely optional. The preferred viewing axes for the main observer and assistant observer, respectively, are designated 17 and 23 according to the embodiments shown, as will be explained hereinafter.

The binocular tubes and eyepieces required for the main observer 21 and assistant observer 22 to use for viewing are not shown on the axes 15, 17, 18 and 23 in the drawings, in the interests of clarity.

The beam pencils 20a to 20d deflected into the horizontal by the deflector 6b strike the deflector 9, as already mentioned. The deflector 9 is constructed so that it deflects only the beam pencils 20c and 20d, while the beam pencils 20a and 20b pass through the deflector 9 without being deflected and strike the binocular tube (not shown) of the viewing axis 17.

The deflector 9 is constructed for example so that the viewing beam pencils 20c, 20d strike reflective regions, and the viewing beam pencils 20a, 20b strike non-reflective regions. For example, the deflector 9 may be constructed as a mirror with corresponding openings for the beam pencils 20a, 20b.

By using a deflector 9 of this kind a design is easily obtained in which the main viewing beam pencils 20a, 20b can easily be spatially separated from the assistant viewing beam pencils 20c, 20d, without any loss of light intensity.

After being deflected by the deflector 9, the viewing beam pencils 20c, 20d strike another deflector designated 10. This deflector 10 may consist overall of a number of deflector components which are connected by a so-called 2a gear so that the viewing beam pencils 20c, 20d can be deflected from the plane of the drawing shown in FIG. 1 about a rotation axis 13.

Instead of the deflector 10 shown, a mechanical interface may also be provided which receives the so-called 180° binocular tube which allows in principle the same deflection but optionally has an overall length that is to be corrected. In addition it should be possible for a separate zoom system and optionally other deflectors, inverting systems for image alignment, beam exchangers, filter inserts and/or imaging lenses for ergonomic beam deflection to be inserted in the assistant's line of viewing. In the embodiment of the stereomicroscope according to the invention as shown it is also possible to provide for rotation of the deflector 10 about the axis 31, as known from the prior art, in addition to or instead of the rotation about the axis 13 described above.

It should be pointed out that the deflection of approximately 90° described for all the deflectors shown is given purely by way of example. Depending on the space available, smaller or larger deflection angles may be necessary or desirable, and this may apply to all spatial directions, which means that skewed deflections are also possible.

In front of the binocular tubes (not shown) for stereoscopic viewing by the main surgeon 21 and assistant 22 on the viewing axes 15, 17, 18, 23 there should also be the option of providing so-called “pull-out extensions” that render the spacing of these tubes from the microscope housing 1 variable, as required. Also on these axes, the tubes can be secured to be advantageously rotatable about this axis through a so-called circular rotatable dovetail.

It is also possible to mount other optical components in the beam paths described, which are designated 8a, b, c in FIG. 1, by way of example. The additional components 8 may be inserted at the specified locations, as desired. Such components may bring about intermediate imaging or pupil displacement, for example. These elements may also be shutters which interrupt or open up the passage of light in various possible combinations in the various viewing channels, as desired. Mechanical shutters or displays with electrochromic activatable coatings may be used. By lining up components along a horizontal axis in this way it is possible to effectively avoid an unergonomic, excessively tall construction, as may be found in conventional ophthalmological assistant-type stereomicroscopes.

The zoom system 7 is expediently characterised in that it allows magnifications e.g. in the region of about 5-30 (corresponding approximately to an expansion factor of 6), each viewing channel expediently consisting of at least three optical groups of which at least one group is fixed. In addition, as already described, the viewing channels should be aligned parallel to one another.

In the representation shown in FIG. 1, the main objective 2 is shown as being symmetrical to its axis 11. It is also possible to arrange the main objective non-centrically thereto. The optical correction of this objective is advantageously achromatic or apochromatic, taking the secondary spectrum into special consideration.

It is also, in principle, possible to mount documentation devices, e.g. cameras, chiefly along the viewing axes on which binocular tubes are typically provided, and it is also possible to use other optical splitters.

With reference to FIG. 1 in particular, it is clear that the beam pencils 20a, 20b (on the vertical stretch) between the object 16 and the first deflector 30 have covered the same travel distance, as they strike the deflector 30 at the same level. By contrast, the distance between the object and the first deflector 30 to be covered accordingly by the beam pencils 20c, 20d is different, on account of the differences in height of the vertical points of impact on the deflector 30, so that in the course of the further passage of light through the microscope, a corresponding equalisation or compensation has to be carried out. According to the invention, such an equalisation is achieved by means of a corresponding number or alignment of other deflectors, in this instance 6a, 6b and 6c, so that when the viewing axis 23 is reached, for example, a corresponding equalisation of distance has taken place.

As already mentioned, the first deflector element 30 is of semitransparent construction, preferably in the form of a physical beam splitter, while embodiments in the form of geometric beam splitters are also possible. In the following description it will be assumed, for simplicity's sake, that it is a physical beam splitter in the form of a semitransparent mirror.

FIG. 1 shows a first illuminating device 50 arranged above the deflector 30. The illuminating device 50 advantageously represents a planar illumination and is formed in particular with OLEDs as the light source. The illuminating device 50 is arranged on the optical axis 11 of the main objective 2, the optical axis 11 preferably striking the middle of the illuminating device 50. OLEDs can be designed to be particularly flat, so that the height of the stereomicroscope 1, which is important for ergonomic reasons, can be kept to a minimum.

In order to achieve planar illumination that is as homogeneous as possible, the illuminating device 50 may have a diffuser which may be constructed for example as a sheet of translucent glass or an array of microlenses. It is also possible to use conventional illuminating means or light sources together with diffusers of this kind as the illuminating device.

Because the first deflector 30 is of semitransparent design, it is possible to illuminate the object 16 by means of the illuminating device 50 through the deflector 30 and the main objective 2, thus providing a 0° illumination, without the illuminating device or any deflectors that cooperate therewith projecting into the viewing beam pencils 20a to 20d and affecting the imaging quality.

For optimum display of the red reflex when an eye is being observed, care must be taken to ensure that the main objective 2 and a lens 16a of the eye focus the light from the illuminating device 50 on the retina 16b or close to it. Particularly in combination with the provision of planar and diffuse light shown, this allows particularly effective and sharp observation of the red reflex.

As the light emanating from the illuminating device 50 is also partly reflected by the first deflector 30, it makes sense to provide light traps 70 which by absorption prevent any unwanted light reflections that occur in this context. It is also possible to focus this light and use it for illumination, for example within the scope of a further illuminating device.

It is also possible to deflect the light reflected from the semitransparent deflector 30 towards the object by means of a further deflector, and use it within the scope of further illumination, for example a 6° illumination. This light could be deflected past the semitransparent deflector 30 and through the main objective 2 onto the object 16, with suitable deflection and suitable sizing of the deflector 30 and main objective 2. It is also conceivable, again if the dimensions are suitably chosen, to deflect this light past the semitransparent deflector 30 and past the main objective 2 onto the object.

It is also possible to provide, instead of the light trap 70, an array of lenses which feed light reflected from the semitransparent deflector 30 into correspondingly associated fibre-optic cables. This light can then also be supplied to a further illuminating device.

A further illuminating device of this kind is designated 3. This illuminating device directs light supplied for example by a fibre-optic cable 4 (or a number of fibre-optic cables) from a light source (not shown) via a deflector 3a onto the object 16 which is to be observed. The main axis of the illuminating device 3 is designated 12. In all, the illuminating device 3 provides an angled illumination, for example a so-called 6° illumination, which is necessary for example for certain observations or interventions in eye surgery. The above-mentioned light which is not transmitted but reflected by the first deflector 30 could for example be supplied to this further illuminating device 3.

FIG. 2 shows another preferred embodiment of the stereomicroscope according to the invention which differs from the embodiment in FIG. 1 solely in respect of the first illuminating device, here generally designated 60, 65.

The first illuminating device for providing 0° illumination according to FIG. 2 comprises a light source 60, which may be arranged at any suitable position, e.g. including outside the microscope body 1. The light supplied by the light source 60 can be carried by fibre-optic cables 65 to suitable positions above the first deflector 30, while any light emerging from the exit ends of the fibre-optic cables (shown schematically and not in perspective and designated 65a) can be shone along or parallel to the optical axis 11 through the first deflector 30 and the main objective 2 onto the object 16. By means of a suitable number or division of the fibre-optic cables 65, here too it is possible to provide an illuminating device which is planar in its effect, and again the diffusers mentioned previously may be used here. According to a particularly advantageous feature, it is possible to assign individual illumination to each viewing channel. This is made possible for example by the fact that the exit ends of the fibre-optic cables are positioned on the extensions of the viewing beam paths 7a-7d running perpendicularly between the main objective and the deflector 30, so that the light emerging from these exit ends travels along the viewing channels through the objective 2. It is also possible to arrange such exit ends of fibre-optic cables in an array, for example with n lines and m columns (n, m=1, 2, 3, . . . ) and to supply individual fibre-optic cables selectively with light. In this way, analogously to the LEDs described hereinbefore, it is possible to obtain planar or selective illumination, for example to provide 0° or 6° illumination. In the case of a cruciform arrangement of four exit ends of fibre-optic cables in which each end is associated with a viewing channel 7a-7d, it is also possible, in particularly advantageous manner, to provide a fifth fibre-optic cable the exit end of which lies on the optical axis 11 of the main objective.

The other components of the microscope shown in FIG. 2 correspond to the representations in FIG. 1 and require no further explanation.

### LIST OF REFERENCE NUMERALS

1 microscope body

2 main objective

3 illuminating device

3a deflector

4 fibre-optic cable

6a, 6b, 6c deflectors

7 zoom system

7a, 7b main viewing channels

7c, 7d assistant viewing channels

8a, 8b, 8c additional components, for example filters, laser shutters, SDI, optical splitters, data feeds

9 deflector for assistant beam path

10 deflector for swivelling the assistant beam path

11 optical axis of the main objective

12 axis of the illuminating device

13 rotation axis of deflector 10

15 viewing axis

16 object, particularly eye

16a lens of the eye

16b retina

17 viewing lens

18 viewing lens

20a, 20b main viewing beam pencil

20c, 20d assistant viewing beam pencil

21 main observer

22 assistant observer

23 assistant's viewing axis

27 central axis of zoom system

30 deflector

31 axis

50 first illuminating device

60 light source

65 fibre-optic cable

65a exit ends

70 light trap

What is claimed is:

1. A stereomicroscope comprising:
a main objective;
a zoom system downstream of the main objective, the zoom system including substantially horizontally extending magnification and viewing channels;
a first deflector between the objective and the zoom system for deflecting viewing beam pencils emanating from the objective into the zoom system, wherein the first deflector is semitransparent; and
a first illuminating device arranged to illuminate an object to be viewed, wherein illumination light from the first illuminating device is transmitted through the first deflector and the main objective.

2. The stereomicroscope according to claim 1, wherein the zoom system comprises at least three magnification and viewing channels extending substantially horizontally.

3. The stereomicroscope according to claim 2, wherein the zoom system comprises four magnification and viewing channels extending substantially horizontally.

4. The stereomicroscope according to claim 1, wherein the main objective has a substantially perpendicularly extending optical axis, and the semitransparent first deflector is arranged at an angle of substantially 45° relative to the optical axis of the main objective.

5. The stereomicroscope according to claim 1, wherein that the first illuminating device is arranged above the first deflector on an opposite side of the first deflector relative to the main objective or the zoom system.

6. The stereomicroscope according to claim 1, wherein the first illuminating device is arranged substantially on an extension of the optical axis of the main objective.

7. The stereomicroscope according to claim 6, wherein the first illuminating device is arranged symmetrically about the optical axis of the main objective.

8. The stereomicroscope according to claim 1, wherein the first illuminating device comprises at least one light-emitting diode.

9. The stereomicroscope according to claim 8, wherein the at least one light-emitting diode includes at least one organic light-emitting diode.

10. The stereomicroscope according to claim 1, wherein the first illuminating device comprises at least one light trap.

11. The stereomicroscope according to claim 1, further comprising another illuminating device arranged to provide a 6° illumination of an object to be viewed.
